(19) United States
(12) Patent Application Publication
(10) Pub. No.: US 2004/0063057 A1
(43) Pub. Date: Apr. 1, 2004

(54) Smelting furnace

(76) Inventor: Johannes Vetter, Meerbusch (DE)

Correspondence Address: Connolly Bove Lodge & Hutz, P O Box 2207, Wilmington, DE, 19899-2207, US

(21) Appl. No.: 10/433,694

(22) PCT Filed: Nov. 30, 2001
(86) PCT No.: PCT/EP01/14024

(30) Foreign Application Priority Data
Dec. 7, 2000 (DE) 100 60 729.2

(51) Int. Cl. F27B 15/00

(52) U.S. Cl. 432/58

(57) ABSTRACT

Up until now, in the case of smelting furnaces, especially smelting furnaces used to melt glass and having a melting unit accommodated in a combustion chamber, the melt being discharged from an outlet opening of the melting unit is regulated by mechanical means using a stopper rod. This entails the disadvantage that the melt flow is very irregular, in addition to which the risk exists that foreign particles might infiltrate the melt.

According to the invention, the outlet opening is provided with a heatable outlet nozzle. The outlet nozzle is made of a material that exhibits good thermal conductivity and that, at the same time, displays low reactivity vis-à-vis the melt such as, for instance, platinum. A control unit regulates the heat output at the outlet nozzle as a function of the temperature of the melt.

The invention ensures a uniform and homogeneous melt flow. The risk of infiltration by foreign substances is minimized.

The invention relates to a smelting furnace, especially to a smelting furnace used to melt glass, having a melting unit accommodated in a combustion chamber, said unit being provided with an inlet opening through which parts to be melted are fed in, as well as with an outlet opening for the molten material.

In a prior-art smelting furnace described in PCT/US9607052, the melting unit consists of a vertically positioned tube that is provided with a gas-tight and fire-proof jacket. The material of which the jacket of the tube is made—normally ceramic material—is a function of the raw material to be melted and it is selected in such a way that reactions between the jacket material and the raw material to be melted are kept to a minimum. The upper end of the tube has an inlet opening through which the raw material is fed. An outlet opening that serves to discharge the melt is located in the lower section.

The melting unit is concentrically accommodated in an insulated steel casing. The annular space formed between the insulation of the casing and the ceramic tube constitutes the combustion chamber, in which the heat needed for the melting process is generated by burning a gas, preferably natural gas. Thus, the material to be melted is fired indirectly. The exhaust gases that are formed during the combustion process are carried off via an exhaust gas line that exits the combustion chamber, so that the gases do not come into contact with the melt or with the raw material.

The melt discharge is normally controlled manually using a stopper rod. On its front end, the stopper rod has a conical stopper rod section that cooperates with the circular outlet opening. By sliding the rod, an annular gap with a varying width is formed at the outlet opening and said gap determines the melt flow. In order to ensure the most uniform melt flow possible, the stopper rod has to be continuously re-adjusted during the melting process as a function of the melt flow. Nevertheless, irregularities in the melt flow are unavoidable, in addition to which a high level of mechanical wear and tear has to be accepted. Moreover, the risk exists that contact of the melt with the stopper rod might allow foreign particles to infiltrate the melt, thus impairing its quality.

Consequently, the objective of the present invention is to improve the purity and homogeneity of the melt in a smelting furnace, especially in a smelting furnace employed to melt glass.

This objective is achieved in a smelting furnace of the above-mentioned type and purpose by means of the features of the characterizing part of patent claim 1.

Therefore, in the case of the invention, the stopper rod employed in prior-art smelting ovens is replaced by a temperature-controllable outlet nozzle. The viscosity of the melt is influenced by regulating the temperature of the outlet nozzle. In this manner, the flow of the melt can be precisely controlled and adjusted. At the same time, the infiltration of foreign constituents is drastically reduced,

For purposes of temperature control, it is particularly suitable to employ, for instance, an electrically powered heating element that is thermally connected to the outlet nozzle. Heating reduces the viscosity of the melt in the area of the outlet nozzle. In this context, the outlet nozzle and the heating element are configured in an ideal manner such that, if the heat is not on, the melt present in the outlet nozzle solidifies, thus shutting the outlet opening.

In a particularly advantageous embodiment of the invention, it is provided for the heat output generated by the heating element to be variable. For this purpose, the heating element is connected to a control unit by means of which the output of the heating element can be regulated as a function of one or more measured physical and/or chemical parameters such as the temperature or viscosity of the melt.

The temperature of the melt constitutes a direct measure of the viscosity of a liquid. This is why, when it comes to regulating the heat output, it is especially advantageous to provide a temperature measurement in the form of a thermoelement arranged in the area of the outlet opening.

In an advantageous embodiment of the invention, the outlet nozzle is made of a material exhibiting good thermal conductivity, but also displaying low reactivity vis-à-vis the chemical composition of the melt. A substance that is particularly well-suited with an eye towards these aspects is, for instance, platinum.

In order to be able to very rapidly control the discharge of the melt through the outlet opening, the outlet nozzle is fitted with a closing mechanism, for instance, a valve or a flap, by means of which the flow of the melt through the outlet nozzle can be rapidly reduced and/or interrupted whenever necessary without the need to change the heat output at the outlet nozzle.

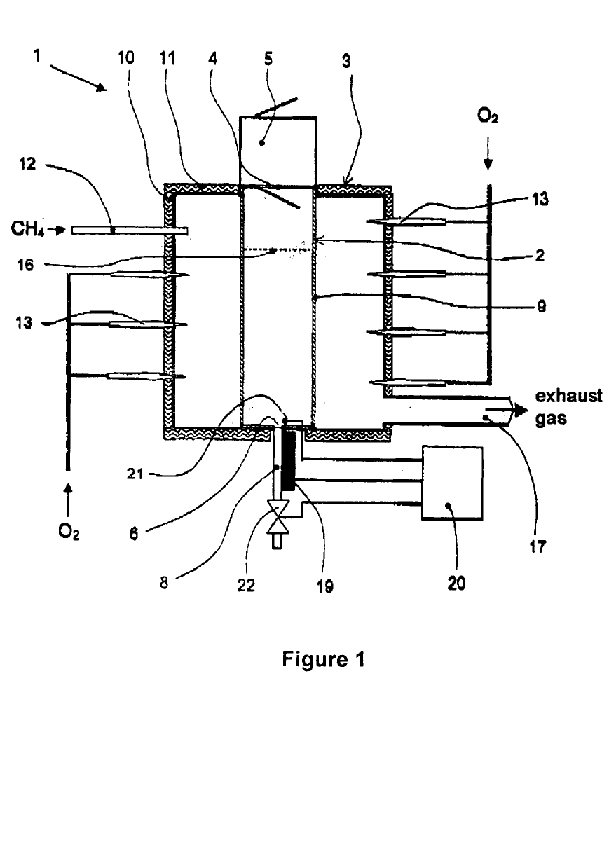

An embodiment of the invention will be explained in greater detail below with reference to the drawing. The single drawing (FIG. 1) schematically shows a cross section of the structure of a smelting furnace according to the invention for melting glass.

The smelting furnace 1 shown in FIG. 1 is a device that serves to melt glass, which is preferably employed to melt down and/or vitrify residual materials or else to melt colored glass.

The smelting furnace 1 comprises an essentially tubular melting unit 2 that is concentrically accommodated in an essentially cylindrical combustion chamber 3. On its upper end, the melting unit 2 has an inlet opening 4 through which raw material to be melted is fed. In order to ensure continuous operation of the smelting furnace 1, there is a lock arrangement upstream from the inlet opening 4. On its lower section, the melting unit 2 has an outlet opening 6 that serves to discharge the melt formed in the melting unit 2. On the outlet opening 6, there is an outlet nozzle 8 that will be explained in greater detail below.

The wall 9 of the melting unit 2 consists of a heat-resistant and gas-tight material, for example, ceramic or metallic material. The material employed here is determined as a function of the type and composition of the substance to be melted. In particular, the material of the wall 9 should be such that, if at all possible, it does not react with the melt that has formed inside the melting unit 2.

A fuel feed line 12 for gaseous fuels, for instance, natural gas, as well as a plurality of injection nozzles 13 for oxygen pass through the wall 11 of the combustion chamber 3, which is provided with an insulating layer 10. The injection nozzles 13 are arranged in a circular pattern at regular angular distances and in several rows at intervals one above the other. A gas exhaust line 17 is provided in order to carry off the exhaust gas formed during the combustion.

The fuel fed in via the fuel feed line 12 is burned with the oxygen fed in via the injection nozzles 13. Here, only a small quantity of oxygen is fed in from the injection nozzles 13 of the uppermost row, while a successively greater quantity of oxygen is fed in from the injection nozzles 13 of the rows below, whereby a total oxygen amount that corresponds to the stoichiometric ratios is fed in. This approach makes it possible to set a temperature profile that is advantageous for the melting process throughout the melting unit 2.

When the smelting furnace 1 is in operation, raw material is fed into the melting unit 2, and said raw material is melted by the heat generated in the combustion chamber 3, up to the height of a melting mirror 16. New raw material can be continuously fed in through the lock arrangement 5 without causing any lasting disturbance of the thermal or chemical conditions inside the melting unit 2 due to the penetration of outside air or the like. Thus, the lock arrangement 5 allows continuous operation of the smelting furnace 1.

For purposes of discharging the melt formed in the melting unit 2 during the melting operation, an outlet nozzle 8 is provided at the outlet opening 6, as mentioned above. This outlet nozzle 8 is a tube piece made of a material that conducts heat well and that is chemically inert such as, for instance, platinum, having a length ranging, for example, from 1 to 4 cm.

The outlet nozzle 8 is thermally connected to a heating device 19. This heating device 19 can be, for example, a heating wire wound around the outlet nozzle 8. By heating the outlet nozzle 8, it is ensured that the melted material present inside the outlet nozzle 8 is in a molten state, that is to say, in a flowable state. Since the viscosity of a melt increases exponentially as the temperature decreases, reducing the heating output brings about a fast rise in the viscosity until the melt solidifies when the value falls below a limit temperature dictated by the composition of the melt, as a consequence of which the melt flow through the outlet nozzle 8 is interrupted.

The heating device 19 is connected to a control unit 20 by means of which the heating output can be regulated. The control unit 20 automatically regulates the heating output of the heating device 19 according to a specified program as a function of the temperature of the melt. In this process, the temperature of the melt is detected continuously or at prescribed intervals by a thermoelement 21 that is located inside the melting unit 2 directly in front of the outlet nozzle 8 or else inside the outlet nozzle 8 and that is likewise connected to the control unit 20 so as to exchange data with it. In this manner, the temperature and thus the viscosity of the melt flow exiting the outlet nozzle 8 can be controlled very precisely during the entire melting operation. Even though, as mentioned above, a reduction in the heating output of the heating device 19 is already sufficient to stop the melt flow through the outlet nozzle 8, sometimes it can be advantageous to additionally regulate or interrupt the melt flow by mechanical means. For this purpose, a valve arrangement 18, for instance, a slide valve, which can be closed or set at a specified flow value either manually or in response to a control command by the control unit 20, is installed downstream from the outlet nozzle 8.

The smelting furnace 1 is compact and can be flexibly employed. By separating the melting and combustion chambers, a simple and low-cost insulation compound can be chosen for the insulating layer 10 of the combustion chamber 3, seeing that there is no spatial contact between the outer insulating layer 10 and the melt. Since it is also the case that the exhaust gas from the combustion chamber 3 does not come in contact with the melt in the melting unit 2, almost 100% of it consists of carbon dioxide and water vapor when natural gas is burned. The smelting furnace 1 can be employed in a continuous operation or in a batch operation and it is particularly well-suited as a complement to conventional tank melting processes.

### List of Reference Numerals

1 smelting furnace

2 melting unit

3 combustion chamber

4 inlet opening

5 lock arrangement

6 outlet opening

7 -

8 outlet nozzle

9 wall (of the melting unit)

10 insulating layer

11 wall (of the combustion chamber)

12 fuel conduit

13 injection nozzle

14 -

15 -

16 melting mirror

17 gas exhaust line

18 valve arrangement

19 heating device

20 control unit

21 thermoelement

1. A smelting furnace, especially a smelting furnace (1) used to melt glass, having a melting unit (2) accommodated in a combustion chamber (3), said unit being provided with an inlet opening (4) through which parts to be melted are fed in, as well as with an outlet opening (6) for the molten material,
characterized in that
the outlet opening (6) is provided with a temperature-controlled outlet nozzle (8).

2. The smelting furnace according to claim 1, characterized in that the temperature of the outlet nozzle (8) is controlled by means of a heating element (19) that is thermally connected to the nozzle.

3. The smelting furnace according to claim 2, characterized in that the heating element (19) is connected to a control unit (20) by means of which the heat output of the heating element (19) can be regulated as a function of physical and/or chemical parameters of the melt such as the temperature or viscosity, determined by means of a measuring instrument (21).

4. The smelting furnace according to claim 3, characterized in that a thermoelement (21) arranged in the area of the outlet opening (6) is employed as the measuring instrument used to determine the temperature of the melt.

5. The smelting furnace according to one of the preceding claims, characterized in that the outlet nozzle (8) is made of a material exhibiting good thermal conductivity, but also displaying low reactivity vis-à-vis the chemical composition of the melt, for instance, platinum.

6. The smelting furnace according to one of the preceding claims, characterized in that the flow of the melt through the outlet nozzle (8) can be reduced and/or interrupted by means of a closing mechanism (22).
